(19) United States
(12) Patent Application Publication
(10) Pub. No.: US 2010/0011639 A1
(43) Pub. Date: Jan. 21, 2010

(54) Message Creation and Display Device

(76) Inventors: Theresa L. Goode, Lakewood, CO (US); Marjie Goode, Littleton, CO (US)

Correspondence Address: JACKSON ESQUIRE;ROGER A. JACKSON, 209 KALAMATH STREET, UNIT 9, DENVER, CO, 80223-1348, US

(21) Appl. No.: 12/503,827

(22) Filed: Jul. 15, 2009

Related U.S. Application Data
(60) Provisional application No. 61/080,884, filed on Jul. 15, 2008.

(51) Int. Cl. G09F 7/00

(52) U.S. Cl. 40/584

(57) ABSTRACT

Broadly the present invention is a message creation and display device and method of using the same, the message creation and display device includes an elongate substrate, a message display surface for displaying a message, wherein the message display surface is disposed upon said elongate substrate, and a plurality of permanent markings disposed upon the elongate substrate outside of the message display surface.

### RELATED APPLICATION

This application claims priority from U.S. provisional patent application Ser. No. 61/080,884 filed Jul. 15, 2008 by Theresa L. Goode and Marjie Goode.

### FIELD OF THE INVENTION

The present invention broadly relates to the conveyance of information on a suitable medium. More particularly, the invention is directed to the creation and display of messages, sayings, slogans or other types of information which may be humorous, motivational, introspective, or the like.

### BACKGROUND

Humankind, by nature, has various means of communication involving one or more of the five senses. Most forms of communication are, perhaps, visual, or audible in nature. Modern communication of the visual type is virtually limitless. Often, people communicate visually by presenting information on a selected medium such as a computer screen, greeting cards, billboards, product packaging, and road signs, to name only a select few. Indeed, much of the media used in visual communication allows for a message or other information that is being conveyed to be updated, replaced, or modified as needed.

In the past, people have used various items and techniques to convey messages which may be comical, newsworthy, or promote positive thinking and introspection. One example of promoting positive thinking is to put a motivating, often humorous, slogan on a coffee cup, or T-shirt, or other display item. Indeed, there are numerous different types of novelty items available for such purposes. Similarly, posters with motivational slogans have been used in the workplace to boost employee morale. In fact, motivational speakers and their self-help books and seminars have become a huge industry directed at teaching others to be successful through positive thinking. As a representative example, one device often used to dissuade people from the bad habit of swearing or being late to a meeting is the “swear jar.” A swear jar is simply a jar with a label that says something like “swear jar—one dollar”. Accordingly, every time someone swears they are to put a dollar in the jar as a penalty.

While these and other means of visual communication have been effectively and creatively used to communicate ideas, such as the deterrence of bad habits and the promotion of more positive thinking and introspection, there remains a need for a message creation and display device having an improved construction. There is further need for such a device which is reusable so that selective messages, such as those which are motivational or satirical in nature, may be presented to an audience. The present invention is directed to meeting these needs.

### SUMMARY

Broadly the present invention is a message creation and display device and method of using the same, the message creation and display device includes an elongate substrate, a message display surface for displaying a message, wherein the message display surface is disposed upon said elongate substrate, and a plurality of permanent markings disposed upon the elongate substrate outside of the message display surface.

### DESCRIPTION OF THE DRAWINGS

FIG. 1 is a front perspective view of an exemplary embodiment of a message creation and display device having a selected saying inscribed thereon;

FIG. 2 is a rear perspective view of the message creation and display device;

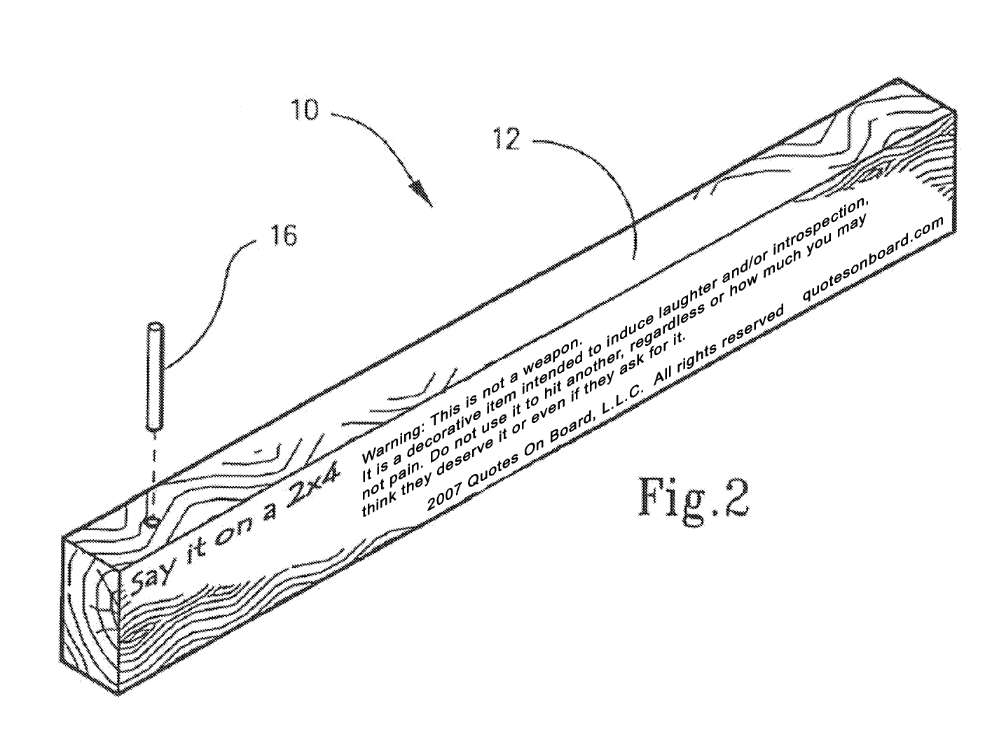

FIG. 3 is a is a front view in elevation of the message creation and display device;

FIG. 4 is a top plan view of the message creation and display device;

FIG. 5 is a rear view in elevation of the message creation and display device;

FIG. 6 is a bottom plan view of the message creation and display device;

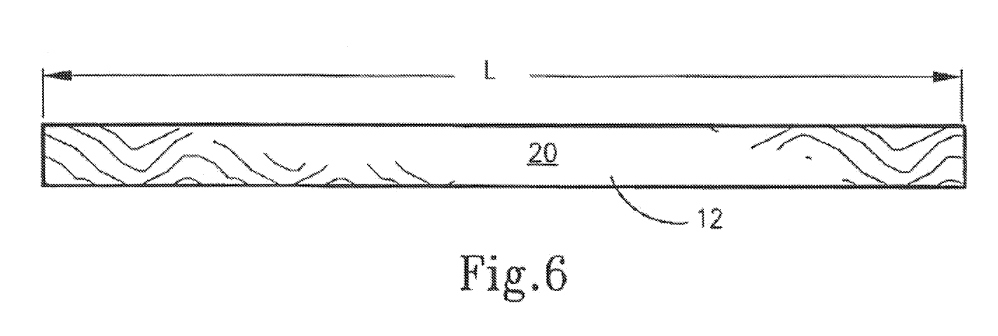

FIG. 7 is a left side view in elevation of the message creation and display device; and

FIG. 8 is a right side view in elevation of the message creation and display device.

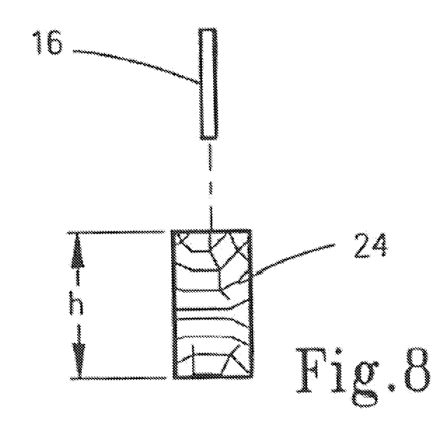

### REFERENCE NUMBERS IN DRAWINGS

10 Device

12 Elongate substrate

14 Message display surface

16 Message inscription implement that is sized and configured to insert into Implement holder 26

18 Top surface of elongate substrate 12

20 Bottom surface of elongate substrate 12

22 Left end surface of elongate substrate 12

24 Right end surface of elongate substrate 12

26 Implement holder for the implement 16

28 Strip material

30 Back surface

32 Other markings that is permanent in nature

“h” Height of elongate substrate 12

“L” Length of elongate substrate 12

### DETAILED DESCRIPTION OF THE EXEMPLARY EMBODIMENT

Described below is a message creation and display device which can be selectively customized to provide any of a variety of different types of sayings. To this end, such sayings or messages may be humorous, motivational, introspective, or the like. Once a customized message has been created, the device may be displayed in any suitable manner. Thereafter, at a user's discretion, alternative messages can be selectively presented thereon.

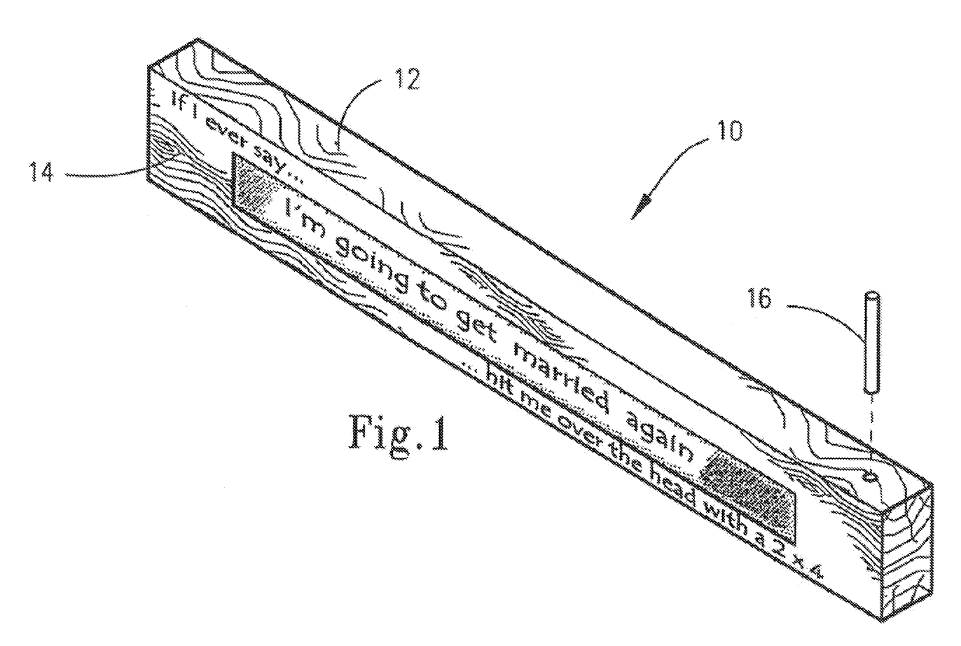

The message creation and display device, or device 10 for short, is initially introduced with reference to FIGS. 1 & 2. Device 10 can broadly include an elongate substrate 12 having a message display surface, generally 14, and a message inscription implement 16. Substrate 12 is comprised of wood and is preferably formed as a piece of standard grade 2×4 lumber cut to a selected length. In the preferred embodiment, the substrate 12 is approximately twenty-four (24) inches in length, although any suitable size is contemplated. The ordinarily skilled artisan will also appreciate that substrate 12 can be formed from a variety of material compositions, e.g., plastics and the like. It is preferred, though certainly not necessary, that substrate 12 at least resemble a piece of lumber.

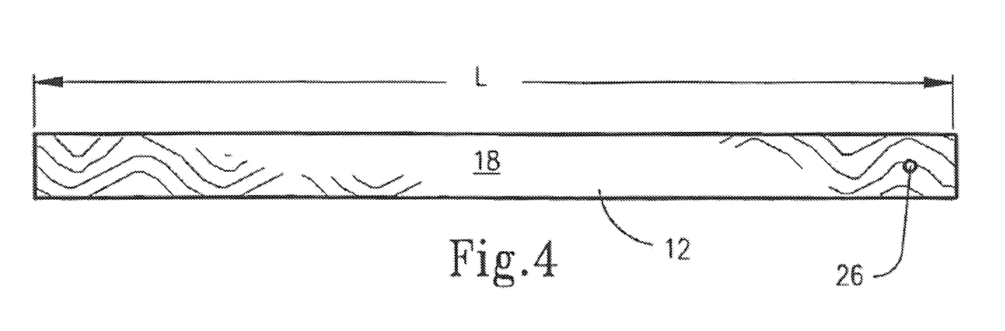

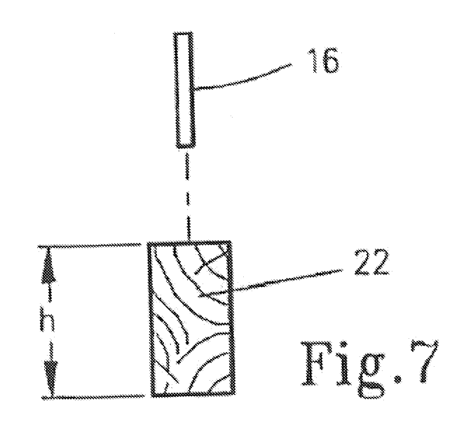

As perhaps appreciated with reference to FIGS. 4 & 6, substrate 12 has a top surface 18 and a bottom surface 20, each of a selected length “L”. As may be seen in FIGS. 7 & 8, substrate 12 also has left and right end surfaces 22 and 24, respectively, which are each at a height “h” of approximately four inches. Associated with upper surface 18 is an implement holder 26 which is formed as a bore that has been drilled into substrate 12. Holder 26 is sized and adapted to accommodate inscription implement 16 for removable insertion therein. Inscription implement 16 is a writing implement which, in the preferred embodiment, is a piece of chalk having a length which approximates the depth of bore 26. Implement 16 is used to inscribe any of a variety of sayings or messages onto the front surface 14 of substrate 12.

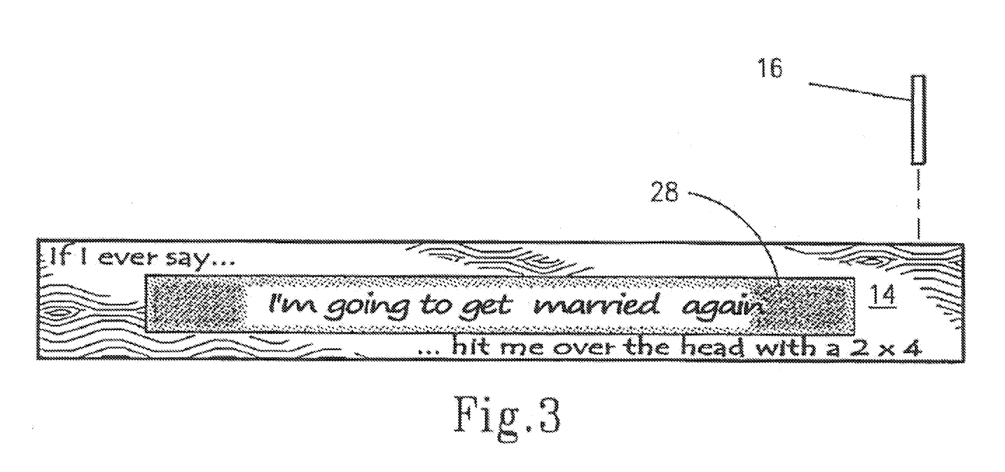

Front surface 14 is best represented in FIG. 3 wherein it may be seen that front surface 14 includes a piece of strip material 28 centered thereon. Strip material 28 provides a writing surface for implement 16, and it may be seen in FIG. 3 that a selected saying “I'm going to get married again” has been inscribed thereon. In the exemplary embodiment, strip material 28 is a non-magnetic, self-adhesive vinyl chalkboard material, such as available from Magically Magnetic, Inc. of Saxonburg, Pa. Conveniently, then, selected messages can be inscribed on strip material 28 with the piece of chalk and thereafter wiped off so that additional messages can be presented thereon.

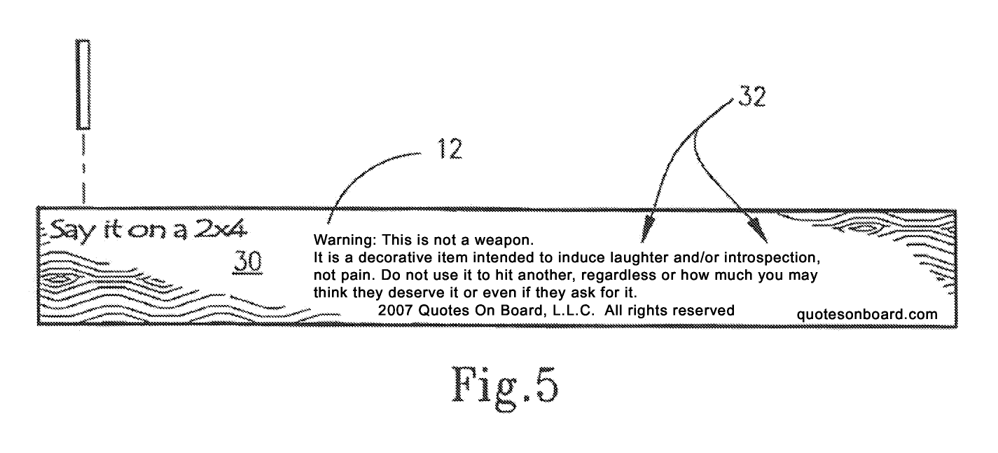

As also shown in FIG. 3, permanent markings are provided on the substrate's front surface 14. In particular, the upper left corner region of front surface 14 includes the phrase “If I ever say . . . ” and the lower right portion of front surface 14 includes the phrase “ . . . hit me over the head with a 2×4.” With a brief reference to FIG. 5, it may also be seen that the back surface 30 of substrate 12 also includes a phrase “Say it on a 2×4”, as well as other indicia generally represented by 32. These phrases and other indicia are permanently marked on the substrate through any suitable marking process, such as engraving, carving, embossing, etching, screen printing, or otherwise. It may be appreciated, then, that there is a correlation between at least some of the markings on substrate 12 and the construction of the substrate itself. In particular, there is a one-to-one correspondence between the construction of the substrate and information permanently marked on it by virtue of the term “2×4”. Thus, when the entire message “If I ever say . . . I'm going to get married again, hit me over the head with a 2×4” is presented to a user or audience member, a functional relationship is perceived between the entire message presented and the substrate. More particularly, the user perceives that the substrate, in a satirical sense, becomes the device which may be used to accomplish the act which is the subject of the terminal portion of the message, namely, “ . . . hit me over the head with a 2×4”. An audience member would, therefore, appreciate the novelty nature of the device 10 and its ability to accommodate any of a variety of sayings on strip material 28 which could achieve a similar effect when viewed.

While the described embodiment includes a piece of chalk as the writing implement and a chalkboard-type material as the writing surface, the artisan will readily appreciate that other types of writing implements and writing surfaces could be employed. Preferably, though, the selected materials for each will allow for reuse so that a variety of sayings or messages may be presented on device 10. In addition, the artisan will appreciate that device 10 can be presented to an audience in a variety of manners. For example, it may be situated on a horizontal surface such as a piece of furniture. Alternative, the device 10 may be mounted to an upright surface, such as a wall, through any of a variety of well-known mounting techniques.

Accordingly, the present invention has been described with some degree of particularity directed to the exemplary embodiment thereof. It should be appreciated, though, that modifications or changes may be made to the exemplary embodiment of the present invention without departing from the inventive concepts contained herein.

1. A message creation and display device, comprising:
(a) an elongate substrate;
(b) a message display surface for displaying a message, wherein said message display surface is disposed upon said elongate substrate; and
(c) a plurality of permanent markings disposed upon said elongate substrate outside of said message display surface.

2. A message creation and display device according to claim 1 further comprising a message inscription implement that is adjacent to said elongate substrate and is operational to facilitate multiple messages upon said message display surface.

3. A message creation and display device according to claim 2 further comprising a holder for removably receiving said implement, wherein said holder is disposed within said elongate substrate.

4. A message creation and display device according to claim 2 wherein said message display surface is a piece of strip material attached to said elongate substrate, said strip material is erasable to facilitate a plurality of messages to be displayed thereon via use of said message inscription implement.

5. A message creation and display device according to claim 1 wherein at least a portion said plurality of permanent markings has a correlation of one-to-one correspondence to said elongate substrate physical structure construction.

6. A message creation and display device according to claim 5 wherein said elongate substrate is constructed of a wood piece sized as about a two (2) inch by about a four (4) inch section of a selected length.

7. A message creation and display device according to claim 6 wherein said message, said portion of plurality of permanent markings, and said elongate substrate form a functional relationship is perceived as between said message, said portion of permanent markings, and said elongate substrate.

8. A message creation and display device according to claim 7 wherein said portion of permanent markings includes sayings selected from the group consisting essentially of “say it on a 2×4”, “If I ever say”, and “hit me over the head with a 2×4”.

9. A message creation and display device according to claim 8 wherein said message has a suffix of “again”.

10. A method of using a message creation and display device according to claim 8 wherein said message has a prefix of “I want another”.

11. A method of using a message creation and display device according to claim 8 wherein said message has a prefix of “I want to have”.

12. A message creation and display device according to claim 1 wherein said device is adapted to be mounted on an upright surface.

13. A method of using a message creation and display device, comprising the steps of:
(a) providing a message creation and display device that includes an elongate substrate of about two (2) inch by four (4) section of a selected length constructed of wood, further included is a message display surface constructed of a strip material for displaying a message that is erasable, wherein said message display surface is attached to said elongate substrate, and also included is a plurality of permanent markings disposed upon said elongate substrate outside of said message display surface, wherein at least a portion said plurality of permanent markings has a correlation of one-to-one correspondence to said elongate substrate physical structure construction; and
(b) creating said message upon said strip material such that said message has content that a functional relationship is perceived as between said portion of permanent markings, said elongate substrate construction, and said message.

14. A method of using a message creation and display device according to claim 13 wherein said portion of permanent markings includes sayings selected from the group consisting essentially of “say it on a 2×4”, “If I ever say”, and “hit me over the head with a 2×4”.

15. A method of using a message creation and display device according to claim 13 wherein said step of creating said message upon said strip material, with said message having a suffix of “again”.

16. A method of using a message creation and display device according to claim 13 wherein said step of creating said message upon said strip material, with said message having a prefix of “I want another”.

17. A method of using a message creation and display device according to claim 13 wherein said step of creating said message upon said strip material, with said message having a prefix of “I want to have”.
